(19) United States
(12) Patent Application Publication
(10) Pub. No.: US 2026/0230359 A1
(43) Pub. Date: Aug. 6, 2026

(54) SOUNDING REFERENCE SIGNAL INSERTION LOSS IMBALANCE INDICATION AND COMPENSATION

(71) Applicant: QUALCOMM Incorporated, San Diego, CA (US)

(72) Inventors: Antti IMMONEN, Helsinki (FI); Timo Ville VINTOLA, San Diego, CA (US); Sumant Jayaraman IYER, San Diego, CA (US); Gokul SRIDHARAN, Sunnyvale, CA (US)

(21) Appl. No.: 19/332,184

(22) Filed: Sep. 18, 2025

Related U.S. Application Data
(60) Provisional application No. 63/754,214, filed on Feb. 5, 2025.

(51) Int. Cl. H04L 27/26; H04W 74/0833

(52) U.S. Cl. CPC H04L 27/261; H04W 74/0833

(57) ABSTRACT

Various aspects of the present disclosure generally relate to wireless communication. In some aspects, a user equipment (UE) may transmit an indication of compensation for insertion loss between sounding reference signal (SRS) ports. The UE may transmit in a first set of SRS resources using a first set of SRS ports. The UE may transmit in a second set of SRS resources using a second set of SRS ports. Each set of SRS ports may consist of one SRS port or two SRS ports, and a transmit power associated with the second set of SRS ports is adjusted to match a transmit power associated with the first set of SRS ports. Numerous other aspects are described.

### CROSS-REFERENCE TO RELATED APPLICATION

This Patent Application claims priority to U.S. Provisional Patent Application No. 63/754,214, filed on February 5, 2025, entitled “SOUNDING REFERENCE SIGNAL INSERTION LOSS IMBALANCE INDICATION AND COMPENSATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with sounding reference signal loss imbalance indication and compensation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In order to communicate wirelessly, a user equipment (UE) may include multiple antennas (or antenna arrays). Some antennas (or antenna arrays) may be used for both transmission to a network and reception from the network. Other antennas (or antenna arrays) may be used only for reception.

### SUMMARY

The systems, methods, and devices of this disclosure each have several innovative aspects, no single one of which is solely responsible for the desirable attributes disclosed herein.

Some aspects described herein relate to an apparatus for wireless communication at a user equipment (UE). The apparatus may include one or more memories and one or more processors. The one or more processors may, individually or collectively and based at least in part on information stored in the one or more memories, be configured to transmit an indication of compensation for insertion loss between sounding reference signal (SRS) ports. The one or more processors may, individually or collectively and based at least in part on information stored in the one or more memories, be configured to transmit in a first set of SRS resources using a first set of SRS ports. The one or more processors may, individually or collectively and based at least in part on information stored in the one or more memories, be configured to transmit in a second set of SRS resources using a second set of SRS ports, wherein each set of SRS ports consists of one SRS port or two SRS ports, and wherein a transmit power associated with the second set of SRS ports is adjusted to match a transmit power associated with the first set of SRS ports.

Some aspects described herein relate to an apparatus for wireless communication at a network node. The apparatus may include one or more memories and one or more processors. The one or more processors may, individually or collectively and based at least in part on information stored in the one or more memories, be configured to receive an indication of compensation for insertion loss between SRS ports of a UE. The one or more processors may, individually or collectively and based at least in part on information stored in the one or more memories, be configured to perform measurements on a first set of SRS resources associated with a first set of SRS ports and on a second set of SRS resources associated with a second set of SRS ports, wherein each set of SRS ports consists of one SRS port or two SRS ports. The one or more processors may, individually or collectively and based at least in part on information stored in the one or more memories, be configured to perform channel estimation using the measurements and assuming a transmit power associated with the second set of SRS ports was adjusted to match a transmit power associated with the first set of SRS ports.

Some aspects described herein relate to an apparatus for wireless communication at a UE. The apparatus may include one or more memories and one or more processors. The one or more processors may, individually or collectively and based at least in part on information stored in the one or more memories, be configured to transmit an indication of a difference between a transmit power associated with a first SRS resource and a transmit power associated with a second SRS resource, wherein the second SRS resource is associated with a first SRS port and a second SRS port. The one or more processors may, individually or collectively and based at least in part on information stored in the one or more memories, be configured to transmit a set of SRSs using the second SRS resource, wherein a transmit power associated with the second SRS port is adjusted to match a transmit power associated with the first SRS port.

Some aspects described herein relate to an apparatus for wireless communication at a UE. The apparatus may include one or more memories and one or more processors. The one or more processors may, individually or collectively and based at least in part on information stored in the one or more memories, be configured to transmit an indication of a difference between a transmit power associated with a reference SRS resource and a transmit power associated with a first SRS port, and a difference between the transmit power associated with the reference SRS resource and a transmit power associated with a second SRS port. The one or more processors may, individually or collectively and based at least in part on information stored in the one or more memories, be configured to transmit a set of SRSs using an SRS resource associated with the first SRS port and the second SRS port, wherein the transmit power associated with the first SRS port is independent of the transmit power associated with the second SRS port.

Some aspects described herein relate to an apparatus for wireless communication at a network node. The apparatus may include one or more memories and one or more processors. The one or more processors may, individually or collectively and based at least in part on information stored in the one or more memories, be configured to receive an indication of a difference between a transmit power associated with a reference SRS resource and a transmit power associated with a first SRS port, and a difference between the transmit power associated with the reference SRS resource and a transmit power associated with a second SRS port. The one or more processors may, individually or collectively and based at least in part on information stored in the one or more memories, be configured to perform measurements using an SRS resource associated with the first SRS port and the second SRS port. The one or more processors may, individually or collectively and based at least in part on information stored in the one or more memories, be configured to perform channel estimation using the measurements and assuming a transmit power associated with the first SRS port is independent of the transmit power associated with the second SRS port.

Some aspects described herein relate to an apparatus for wireless communication at a UE. The apparatus may include one or more memories and one or more processors. The one or more processors may, individually or collectively and based at least in part on information stored in the one or more memories, be configured to receive a plurality of SRS configurations for an SRS port. The one or more processors may, individually or collectively and based at least in part on information stored in the one or more memories, be configured to transmit using the SRS port and a selected SRS configuration from the plurality of SRS configurations, wherein the selected SRS configuration is determined using a difference between a transmit power associated with a reference SRS port and a transmit power associated with the SRS port.

Some aspects described herein relate to an apparatus for wireless communication at a network node. The apparatus may include one or more memories and one or more processors. The one or more processors may, individually or collectively and based at least in part on information stored in the one or more memories, be configured to transmit a plurality of SRS configurations for an SRS port. The one or more processors may, individually or collectively and based at least in part on information stored in the one or more memories, be configured to perform measurements using an SRS resource associated with the SRS port. The one or more processors may, individually or collectively and based at least in part on information stored in the one or more memories, be configured to perform channel estimation using the measurements and a selected SRS configuration, from the plurality of SRS configurations, that indicates a difference between a transmit power associated with a reference SRS port and a transmit power associated with the SRS port.

Some aspects described herein relate to a method of wireless communication performed by a UE. The method may include transmitting, by the UE, an indication of compensation for insertion loss between SRS ports. The method may include transmitting, by the UE, in a first set of SRS resources using a first set of SRS ports. The method may include transmitting, by the UE, in a second set of SRS resources using a second set of SRS ports, wherein each set of SRS ports consists of one SRS port or two SRS ports, and wherein a transmit power associated with the second set of SRS ports is adjusted to match a transmit power associated with the first set of SRS ports.

Some aspects described herein relate to a method of wireless communication performed by a network node. The method may include receiving, by the network node, an indication of compensation for insertion loss between SRS ports of a UE. The method may include performing measurements, by the network node, on a first set of SRS resources associated with a first set of SRS ports and on a second set of SRS resources associated with a second set of SRS ports, wherein each set of SRS ports consists of one SRS port or two SRS ports. The method may include performing channel estimation, by the network node, using the measurements and assuming a transmit power associated with the second set of SRS ports was adjusted to match a transmit power associated with the first set of SRS ports.

Some aspects described herein relate to a method of wireless communication performed by a UE. The method may include transmitting, by the UE, an indication of a difference between a transmit power associated with a first SRS resource and a transmit power associated with a second SRS resource, wherein the second SRS resource is associated with a first SRS port and a second SRS port. The method may include transmitting, by the UE, a set of SRSs using the second SRS resource, wherein a transmit power associated with the second SRS port is adjusted to match a transmit power associated with the first SRS port.

Some aspects described herein relate to a method of wireless communication performed by a UE. The method may include transmitting, by the UE, an indication of a difference between a transmit power associated with a reference SRS resource and a transmit power associated with a first SRS port, and a difference between the transmit power associated with the reference SRS resource and a transmit power associated with a second SRS port. The method may include transmitting, by the UE, a set of SRSs using an SRS resource associated with the first SRS port and the second SRS port, wherein the transmit power associated with the first SRS port is independent of the transmit power associated with the second SRS port.

Some aspects described herein relate to a method of wireless communication performed by a network node. The method may include receiving, by the network node, an indication of a difference between a transmit power associated with a reference SRS resource and a transmit power associated with a first SRS port, and a difference between the transmit power associated with the reference SRS resource and a transmit power associated with a second SRS port. The method may include performing measurements, by the network node, using an SRS resource associated with the first SRS port and the second SRS port. The method may include performing channel estimation, by the network node, using the measurements and assuming a transmit power associated with the first SRS port is independent of the transmit power associated with the second SRS port.

Some aspects described herein relate to a method of wireless communication performed by a UE. The method may include receiving, by the UE, a plurality of SRS configurations for an SRS port. The method may include transmitting, by the UE, using the SRS port and a selected SRS configuration from the plurality of SRS configurations, wherein the selected SRS configuration is determined using a difference between a transmit power associated with a reference SRS port and a transmit power associated with the SRS port.

Some aspects described herein relate to a method of wireless communication performed by a network node. The method may include transmitting, by the network node, a plurality of SRS configurations for an SRS port. The method may include performing measurements, by the network node, using an SRS resource associated with the SRS port. The method may include performing channel estimation, by the network node, using the measurements and a selected SRS configuration, from the plurality of SRS configurations, that indicates a difference between a transmit power associated with a reference SRS port and a transmit power associated with the SRS port.

Some aspects described herein relate to a non-transitory computer-readable medium that stores a set of instructions for wireless communication by a UE. The set of instructions, when executed by one or more processors of the UE, may cause the UE to transmit an indication of compensation for insertion loss between SRS ports. The set of instructions, when executed by one or more processors of the UE, may cause the UE to transmit in a first set of SRS resources using a first set of SRS ports. The set of instructions, when executed by one or more processors of the UE, may cause the UE to transmit in a second set of SRS resources using a second set of SRS ports, wherein each set of SRS ports consists of one SRS port or two SRS ports, and wherein a transmit power associated with the second set of SRS ports is adjusted to match a transmit power associated with the first set of SRS ports.

Some aspects described herein relate to a non-transitory computer-readable medium that stores a set of instructions for wireless communication by a network node. The set of instructions, when executed by one or more processors of the network node, may cause the network node to receive an indication of compensation for insertion loss between SRS ports of a UE. The set of instructions, when executed by one or more processors of the network node, may cause the network node to perform measurements on a first set of SRS resources associated with a first set of SRS ports and on a second set of SRS resources associated with a second set of SRS ports, wherein each set of SRS ports consists of one SRS port or two SRS ports. The set of instructions, when executed by one or more processors of the network node, may cause the network node to perform channel estimation using the measurements and assuming a transmit power associated with the second set of SRS ports was adjusted to match a transmit power associated with the first set of SRS ports.

Some aspects described herein relate to a non-transitory computer-readable medium that stores a set of instructions for wireless communication by a UE. The set of instructions, when executed by one or more processors of the UE, may cause the UE to transmit an indication of a difference between a transmit power associated with a first SRS resource and a transmit power associated with a second SRS resource, wherein the second SRS resource is associated with a first SRS port and a second SRS port. The set of instructions, when executed by one or more processors of the UE, may cause the UE to transmit a set of SRSs using the second SRS resource, wherein a transmit power associated with the second SRS port is adjusted to match a transmit power associated with the first SRS port.

Some aspects described herein relate to a non-transitory computer-readable medium that stores a set of instructions for wireless communication by a UE. The set of instructions, when executed by one or more processors of the UE, may cause the UE to transmit an indication of a difference between a transmit power associated with a reference SRS resource and a transmit power associated with a first SRS port, and a difference between the transmit power associated with the reference SRS resource and a transmit power associated with a second SRS port. The set of instructions, when executed by one or more processors of the UE, may cause the UE to transmit a set of SRSs using an SRS resource associated with the first SRS port and the second SRS port, wherein the transmit power associated with the first SRS port is independent of the transmit power associated with the second SRS port.

Some aspects described herein relate to a non-transitory computer-readable medium that stores a set of instructions for wireless communication by a network node. The set of instructions, when executed by one or more processors of the network node, may cause the network node to receive an indication of a difference between a transmit power associated with a reference SRS resource and a transmit power associated with a first SRS port, and a difference between the transmit power associated with the reference SRS resource and a transmit power associated with a second SRS port. The set of instructions, when executed by one or more processors of the network node, may cause the network node to perform measurements using an SRS resource associated with the first SRS port and the second SRS port. The set of instructions, when executed by one or more processors of the network node, may cause the network node to perform channel estimation using the measurements and assuming a transmit power associated with the first SRS port is independent of the transmit power associated with the second SRS port.

Some aspects described herein relate to a non-transitory computer-readable medium that stores a set of instructions for wireless communication by a UE. The set of instructions, when executed by one or more processors of the UE, may cause the UE to receive a plurality of SRS configurations for an SRS port. The set of instructions, when executed by one or more processors of the UE, may cause the UE to transmit using the SRS port and a selected SRS configuration from the plurality of SRS configurations, wherein the selected SRS configuration is determined using a difference between a transmit power associated with a reference SRS port and a transmit power associated with the SRS port.

Some aspects described herein relate to a non-transitory computer-readable medium that stores a set of instructions for wireless communication by a network node. The set of instructions, when executed by one or more processors of the network node, may cause the network node to transmit a plurality of SRS configurations for an SRS port. The set of instructions, when executed by one or more processors of the network node, may cause the network node to perform measurements using an SRS resource associated with the SRS port. The set of instructions, when executed by one or more processors of the network node, may cause the network node to perform channel estimation using the measurements and a selected SRS configuration, from the plurality of SRS configurations, that indicates a difference between a transmit power associated with a reference SRS port and a transmit power associated with the SRS port.

Some aspects described herein relate to an apparatus for wireless communication. The apparatus may include means for transmitting an indication of compensation for insertion loss between SRS ports. The apparatus may include means for transmitting in a first set of SRS resources using a first set of SRS ports. The apparatus may include means for transmitting in a second set of SRS resources using a second set of SRS ports, wherein each set of SRS ports consists of one SRS port or two SRS ports, and wherein a transmit power associated with the second set of SRS ports is adjusted to match a transmit power associated with the first set of SRS ports.

Some aspects described herein relate to an apparatus for wireless communication. The apparatus may include means for receiving an indication of compensation for insertion loss between SRS ports of a UE. The apparatus may include means for performing measurements on a first set of SRS resources associated with a first set of SRS ports and on a second set of SRS resources associated with a second set of SRS ports, wherein each set of SRS ports consists of one SRS port or two SRS ports. The apparatus may include means for performing channel estimation using the measurements and assuming a transmit power associated with the second set of SRS ports was adjusted to match a transmit power associated with the first set of SRS ports.

Some aspects described herein relate to an apparatus for wireless communication. The apparatus may include means for transmitting an indication of a difference between a transmit power associated with a first SRS resource and a transmit power associated with a second SRS resource, wherein the second SRS resource is associated with a first SRS port and a second SRS port. The apparatus may include means for transmitting a set of SRSs using the second SRS resource, wherein a transmit power associated with the second SRS port is adjusted to match a transmit power associated with the first SRS port.

Some aspects described herein relate to an apparatus for wireless communication. The apparatus may include means for transmitting an indication of a difference between a transmit power associated with a reference SRS resource and a transmit power associated with a first SRS port, and a difference between the transmit power associated with the reference SRS resource and a transmit power associated with a second SRS port. The apparatus may include means for transmitting a set of SRSs using an SRS resource associated with the first SRS port and the second SRS port, wherein the transmit power associated with the first SRS port is independent of the transmit power associated with the second SRS port.

Some aspects described herein relate to an apparatus for wireless communication. The apparatus may include means for receiving an indication of a difference between a transmit power associated with a reference SRS resource and a transmit power associated with a first SRS port, and a difference between the transmit power associated with the reference SRS resource and a transmit power associated with a second SRS port. The apparatus may include means for performing measurements using an SRS resource associated with the first SRS port and the second SRS port. The apparatus may include means for performing channel estimation using the measurements and assuming a transmit power associated with the first SRS port is independent of the transmit power associated with the second SRS port.

Some aspects described herein relate to an apparatus for wireless communication. The apparatus may include means for receiving a plurality of SRS configurations for an SRS port. The apparatus may include means for transmitting using the SRS port and a selected SRS configuration from the plurality of SRS configurations, wherein the selected SRS configuration is determined using a difference between a transmit power associated with a reference SRS port and a transmit power associated with the SRS port.

Some aspects described herein relate to an apparatus for wireless communication. The apparatus may include means for transmitting a plurality of SRS configurations for an SRS port. The apparatus may include means for performing measurements using an SRS resource associated with the SRS port. The apparatus may include means for performing channel estimation using the measurements and a selected SRS configuration, from the plurality of SRS configurations, that indicates a difference between a transmit power associated with a reference SRS port and a transmit power associated with the SRS port.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of sounding reference signal (SRS) resource sets.

FIG. 4 is a diagram illustrating an example associated with indicating compensation for insertion loss between SRS ports.

FIG. 5 is a diagram illustrating an example associated with power equalization within an SRS resource.

FIG. 6 is a diagram illustrating an example associated with reporting power differences between SRS ports.

FIG. 7 is a diagram illustrating an example associated with using power differences to choose between SRS configurations.

FIG. 8 is a diagram illustrating an example process performed, for example, by a user equipment (UE).

FIG. 9 is a diagram illustrating an example process performed, for example, by a network node or an apparatus of a network node.

FIGS. 10 and 11 are diagrams illustrating example processes performed, for example, by a UE.

FIG. 12 is a diagram illustrating an example process performed, for example, by a network node.

FIG. 13 is a diagram illustrating an example process performed, for example, by a UE.

FIG. 14 is a diagram illustrating an example process performed, for example, by a network node.

FIGS. 15 and 16 are diagrams of example apparatuses for wireless communication.

### DETAILED DESCRIPTION

In a wireless network, a network may configure a user equipment (UE) to transmit a reference signal (e.g., a sounding reference signal (SRS)) so that the network may measure the reference signal and estimate a channel between the network and the UE. The UE, however, may have some antennas (or antenna arrays) that are generally used only for reception from the network. The UE may still transmit the reference signal from those antennas (or antenna arrays) but may introduce some insertion loss (IL) in doing so. For example, the UE may use a power amplifier (PA) in a reception chain for a reception-only antenna (or antenna array) to transmit the reference signal in such a way that IL will be introduced.

Because of imbalance caused by the IL, the network may inaccurately estimate a channel between the network and the (reception-only antenna or antenna array of the) UE. In particular, the network may incorrectly calculate that the channel is weaker because of the IL. Therefore, the network may select a modulation and coding scheme (MCS) or another transmission parameter that reduces throughput on the channel, resulting in increased network overhead. Additionally, or alternatively, the network may avoid transmitting to the reception-only antenna or antenna array of the UE, which may similarly reduce throughput to the UE and thus increase network overhead.

Various aspects relate generally to indications associated with IL at a UE. Some aspects more specifically relate to the UE indicating whether the UE compensates for insertion loss between SRS ports. Additionally, or alternatively, some aspects more specifically relate to the UE adjusting transmit power of SRS ports within a same SRS resource in order to match transmit powers. As used herein, “match” may refer to a numerical match within a predefined margin of error (e.g., a margin of error of 5% or 1%, among other examples). Alternatively, some aspects more specifically relate to the UE indicating differences between a transmit power associated with a reference SRS resource (or SRS port) and transmit powers associated with other SRS ports. Alternatively, some aspects more specifically relate to a network providing a plurality of SRS configurations for an SRS port and the UE selecting from the plurality of SRS configurations using a difference between a transmit power associated with a reference SRS port and a transmit power associated with the SRS port.

Particular aspects of the subject matter described in this disclosure can be implemented to realize one or more of the following potential advantages. In some examples, the described techniques can be used to improve accuracy of channel estimation at the network. For example, because the network is aware of whether the UE is compensating for IL or of differences in transmit power between SRS resources or ports (e.g., caused by the IL), the network may estimate a channel between the network and the (reception-only antennas or antenna arrays of the) UE more accuracy. As a result, the network may improve throughput to the UE, which reduces network overhead.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

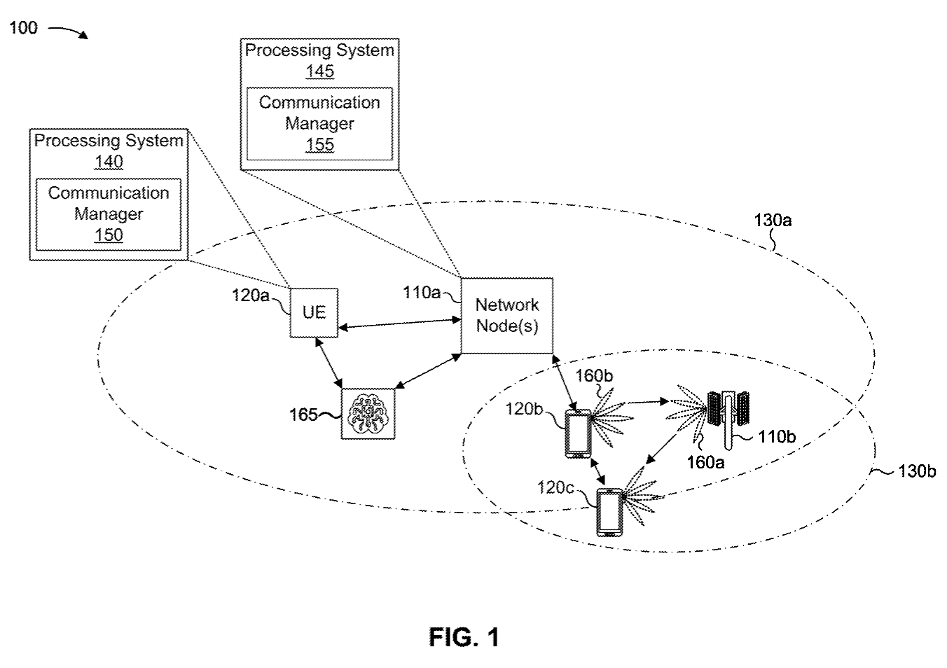

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In the wireless communication network 100, a network node 110 may estimate a channel between the network node 110 and a UE 120. Accordingly, the network node 110 may configure SRS resources in which the UE 120 may transmit so that the network node 110 may perform measurements on the SRS resources and perform channel estimation using the measurements. Therefore, the network node 110 may use the channel estimation to configure uplink resources for the UE 120 to use.

In some aspects, the UE 120 may include a processing system 140 with a communication manager 150. As described in more detail elsewhere herein, the communication manager 150 may transmit (e.g., to the network node 110) an indication of compensation for insertion loss between SRS ports, may transmit (e.g., to the network node 110) in a first set of SRS resources using a first set of SRS ports, and may transmit (e.g., to the network node 110) in a second set of SRS resources using a second set of SRS ports, where each set of SRS ports consists of one SRS port or two SRS ports, and where a transmit power associated with the second set of SRS ports is adjusted to match a transmit power associated with the first set of SRS ports. Additionally, or alternatively, as described in more detail elsewhere herein, the communication manager 150 may transmit (e.g., to the network node 110) an indication of a difference between a transmit power associated with a first SRS resource and a transmit power associated with a second SRS resource, where the second SRS resource is associated with a first SRS port and a second SRS port, and may transmit (e.g., to the network node 110) a set of SRSs using the second SRS resource, where a transmit power associated with the second SRS port is adjusted to match a transmit power associated with the first SRS port. Additionally, or alternatively, as described in more detail elsewhere herein, the communication manager 150 may transmit (e.g., to the network node 110) an indication of a difference between a transmit power associated with a reference SRS resource and a transmit power associated with a first SRS port, and a difference between the transmit power associated with the reference SRS resource and a transmit power associated with a second SRS port, and may transmit (e.g., to the network node 110) a set of SRSs using an SRS resource associated with the first SRS port and the second SRS port, where the transmit power associated with the first SRS port is independent of the transmit power associated with the second SRS port. Additionally, or alternatively, as described in more detail elsewhere herein, the communication manager 150 may receive (e.g., from the network node 110) a plurality of SRS configurations for an SRS port and may transmit (e.g., to the network node 110) using the SRS port and a selected SRS configuration from the plurality of SRS configurations, where the selected SRS configuration is determined using a difference between a transmit power associated with a reference SRS port and a transmit power associated with the SRS port. Additionally, or alternatively, the communication manager 150 may perform one or more other operations described herein.

In some aspects, the network node 110 may include a processing system 145 with a communication manager 155. As described in more detail elsewhere herein, the communication manager 155 may receive (e.g., from the UE 120) an indication of compensation for insertion loss between SRS ports of a UE 120, may perform measurements on a first set of SRS resources associated with a first set of SRS ports and on a second set of SRS resources associated with a second set of SRS ports, where each set of SRS ports consists of one SRS port or two SRS ports, and may perform channel estimation using the measurements and assuming a transmit power associated with the second set of SRS ports was adjusted to match a transmit power associated with the first set of SRS ports. Additionally, or alternatively, as described in more detail elsewhere herein, the communication manager 155 may receive (e.g., from the UE 120) an indication of a difference between a transmit power associated with a reference SRS resource and a transmit power associated with a first SRS port, and a difference between the transmit power associated with the reference SRS resource and a transmit power associated with a second SRS port, may perform measurements using an SRS resource associated with the first SRS port and the second SRS port, and may perform channel estimation using the measurements and assuming a transmit power associated with the first SRS port is independent of the transmit power associated with the second SRS port. Additionally, or alternatively, as described in more detail elsewhere herein, the communication manager 155 may transmit (e.g., to the UE 120) a plurality of SRS configurations for an SRS port, may perform measurements using an SRS resource associated with the SRS port, and may perform channel estimation using the measurements and a selected SRS configuration, from the plurality of SRS configurations, that indicates a difference between a transmit power associated with a reference SRS port and a transmit power associated with the SRS port. Additionally, or alternatively, the communication manager 155 may perform one or more other operations described herein.

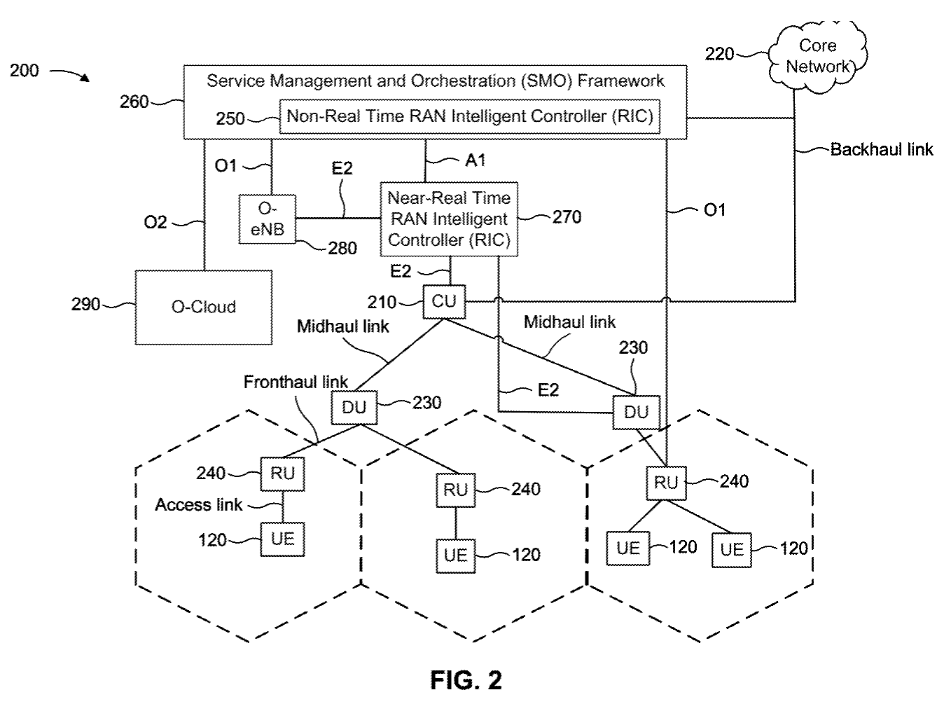

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

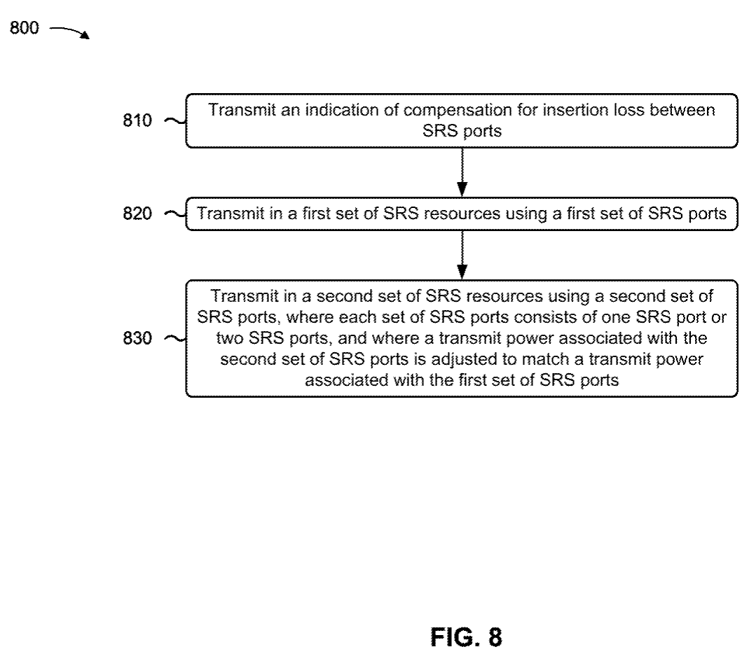

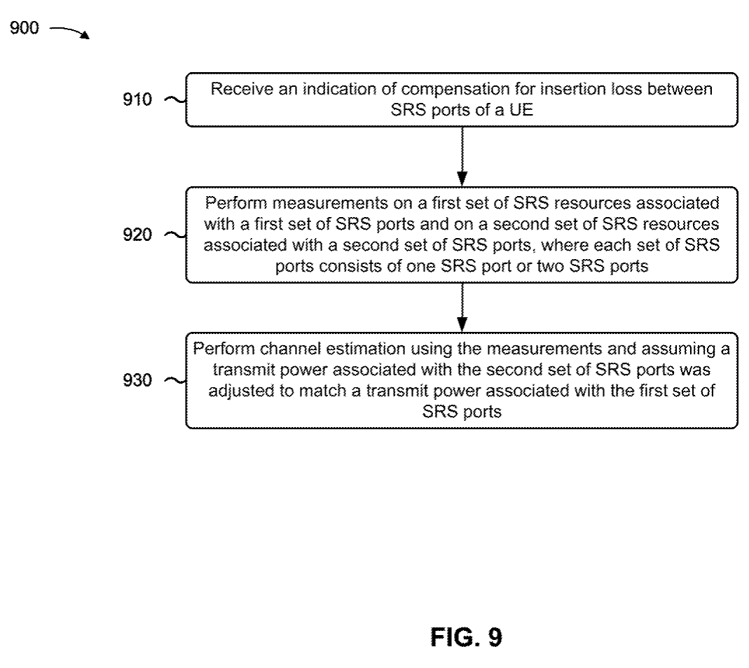

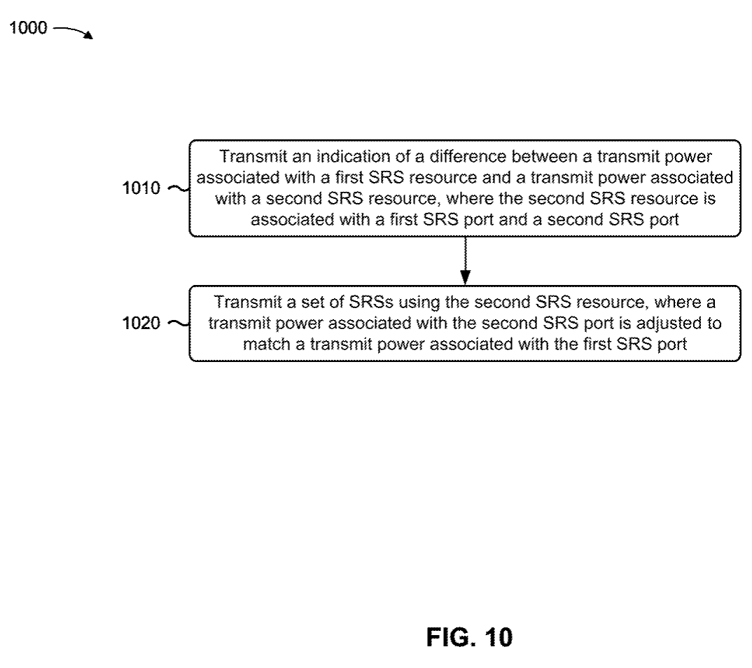

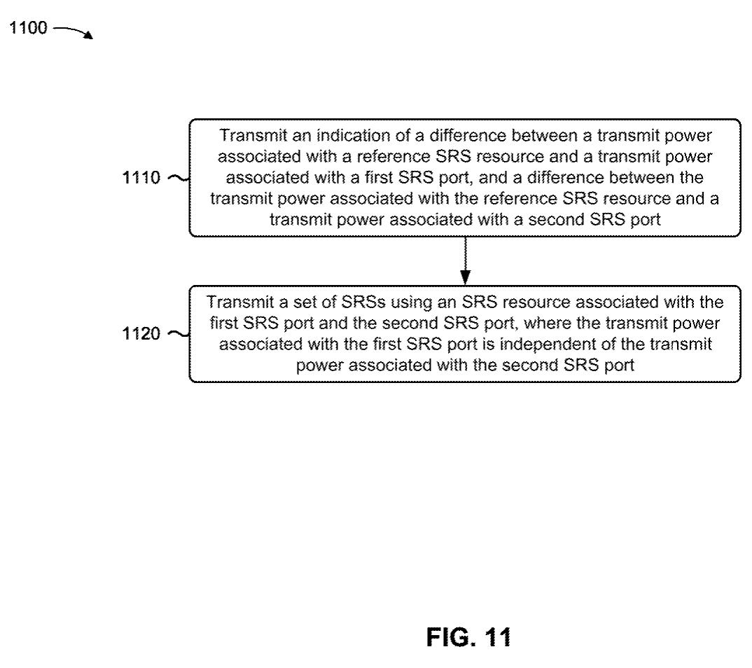

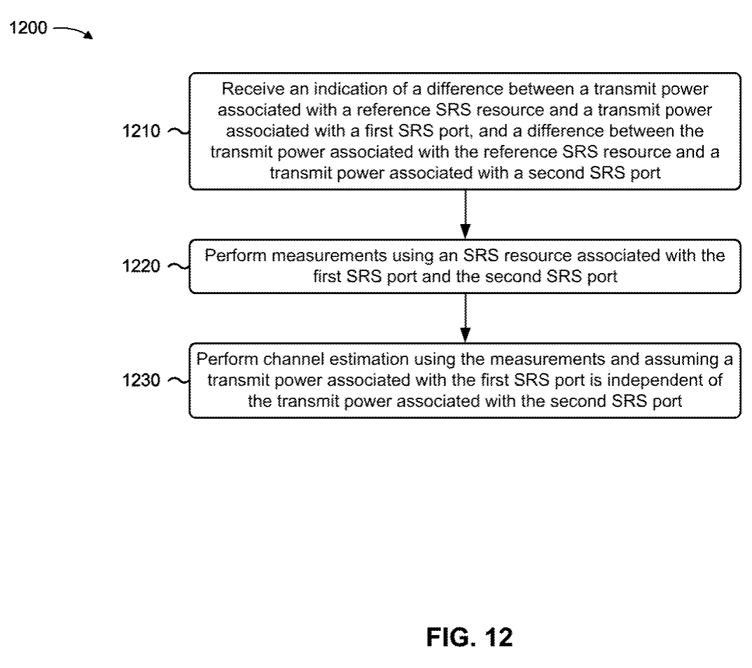

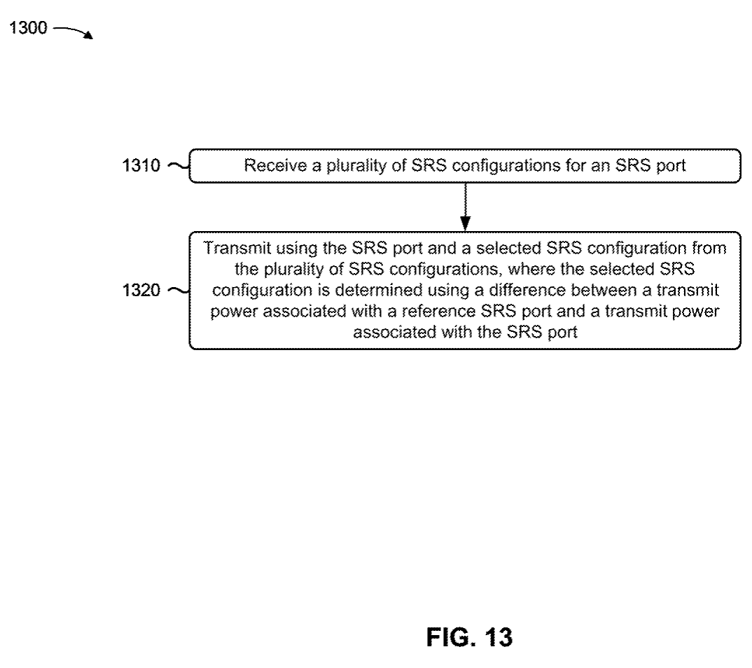

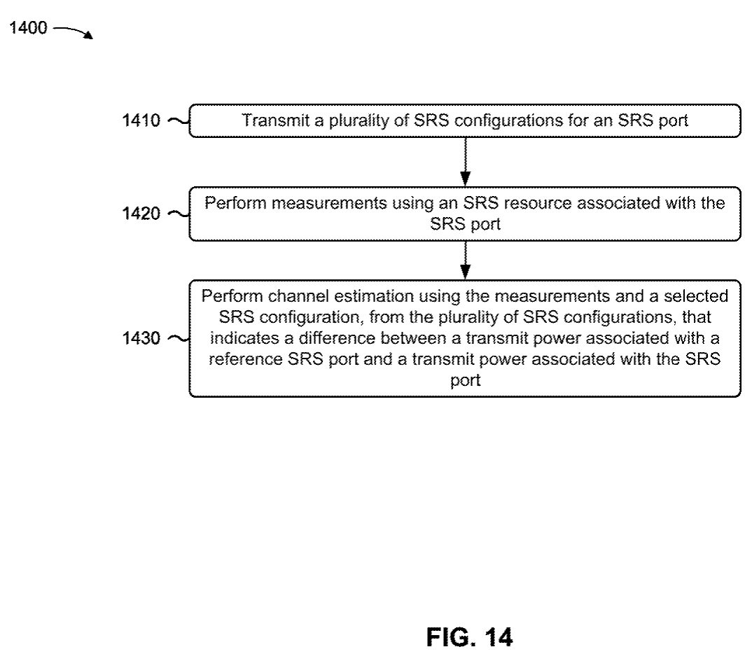

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with SRS loss imbalance indication and compensation, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, process 1000 of FIG. 10, process 1100 of FIG. 11, process 1200 of FIG. 12, process 1300 of Fig, 13, process 1400 of FIG. 14, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, process 1000 of FIG. 10, process 1100 of FIG. 11, process 1200 of FIG. 12, process 1300 of FIG. 13, process 1400 of FIG. 14, or other processes as described herein. In some examples, executing instructions may include running the instructions, converting the instructions, compiling the instructions, or interpreting the instructions, among other examples.

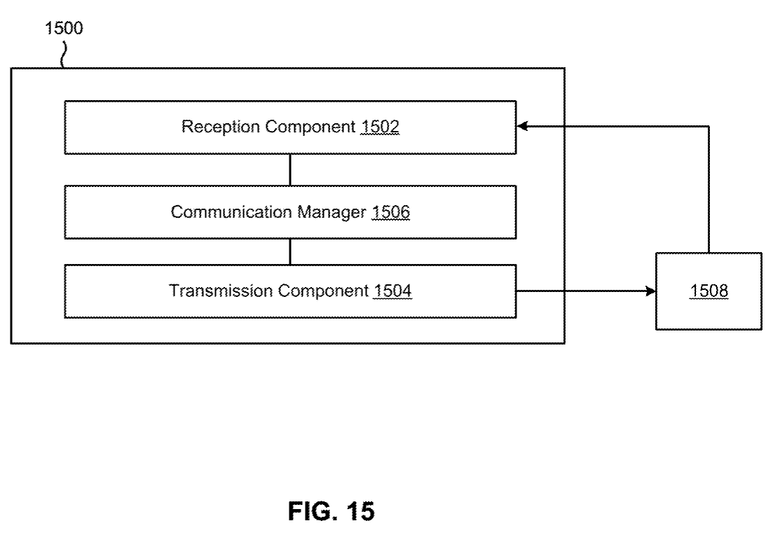

In some aspects, a UE (e.g., UE 120 or apparatus 1500 of FIG. 15) may include means for transmitting an indication of compensation for insertion loss between SRS ports; means for transmitting in a first set of SRS resources using a first set of SRS ports; and means for transmitting in a second set of SRS resources using a second set of SRS ports, wherein each set of SRS ports consists of one SRS port or two SRS ports, and wherein a transmit power associated with the second set of SRS ports is adjusted to match a transmit power associated with the first set of SRS ports. Additionally, or alternatively, the UE may include means for transmitting an indication of a difference between a transmit power associated with a first SRS resource and a transmit power associated with a second SRS resource, wherein the second SRS resource is associated with a first SRS port and a second SRS port; and means for transmitting a set of SRSs using the second SRS resource, wherein a transmit power associated with the second SRS port is adjusted to match a transmit power associated with the first SRS port. Additionally, or alternatively, the UE may include means for transmitting an indication of a difference between a transmit power associated with a reference SRS resource and a transmit power associated with a first SRS port, and a difference between the transmit power associated with the reference SRS resource and a transmit power associated with a second SRS port; and means for transmitting a set of SRSs using an SRS resource associated with the first SRS port and the second SRS port, wherein the transmit power associated with the first SRS port is independent of the transmit power associated with the second SRS port. Additionally, or alternatively, the UE may include means for receiving a plurality of SRS configurations for an SRS port; and means for transmitting using the SRS port and a selected SRS configuration from the plurality of SRS configurations, wherein the selected SRS configuration is determined using a difference between a transmit power associated with a reference SRS port and a transmit power associated with the SRS port. The means for the UE to perform operations described herein may include, for example, one or more of communication manager 150, processing system 140, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

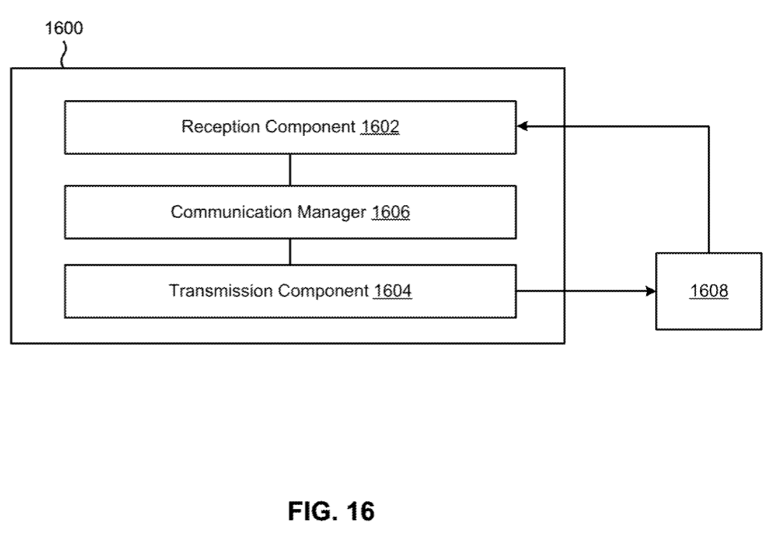

In some aspects, a network node (e.g., network node 110, RU 240, DU 230, CU 210, or apparatus 1600 of FIG. 16) may include means for receiving an indication of compensation for insertion loss between SRS ports of a UE; means for performing measurements on a first set of SRS resources associated with a first set of SRS ports and on a second set of SRS resources associated with a second set of SRS ports, wherein each set of SRS ports consists of one SRS port or two SRS ports; and means for performing channel estimation using the measurements and assuming a transmit power associated with the second set of SRS ports was adjusted to match a transmit power associated with the first set of SRS ports. Additionally, or alternatively, the network node may include means for receiving an indication of a difference between a transmit power associated with a reference SRS resource and a transmit power associated with a first SRS port, and a difference between the transmit power associated with the reference SRS resource and a transmit power associated with a second SRS port; means for performing measurements using an SRS resource associated with the first SRS port and the second SRS port; and means for performing channel estimation using the measurements and assuming a transmit power associated with the first SRS port is independent of the transmit power associated with the second SRS port. Additionally, or alternatively, the network node may include means for transmitting a plurality of SRS configurations for an SRS port; means for performing measurements using an SRS resource associated with the SRS port; and means for performing channel estimation using the measurements and a selected SRS configuration, from the plurality of SRS configurations, that indicates a difference between a transmit power associated with a reference SRS port and a transmit power associated with the SRS port. The means for the network node to perform operations described herein may include, for example, one or more of communication manager 155, processing system 145, a radio, one or more RF chains, one or more transceivers, one or more antennas, one or more modems, a reception component (for example, reception component 1602 depicted and described in connection with FIG. 16), or a transmission component (for example, transmission component 1604 depicted and described in connection with FIG. 16), among other examples.

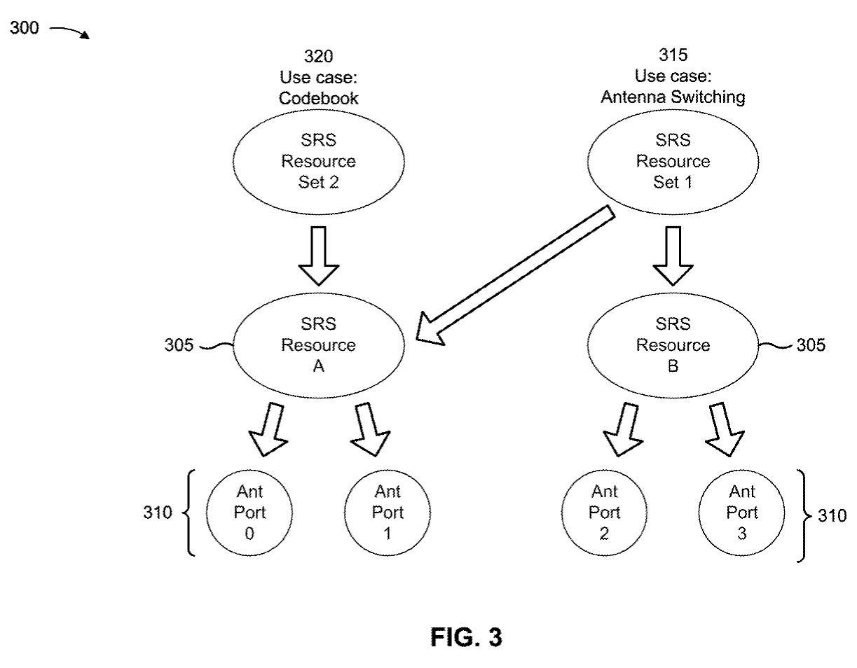

FIG. 3 is a diagram illustrating an example 300 of SRS resource sets. A UE 120 may be configured with one or more SRS resource sets to allocate resources for SRS transmissions by the UE 120. For example, a configuration for SRS resource sets may be indicated in a radio resource control (RRC) message (e.g., an RRC configuration message or an RRC reconfiguration message). As shown by reference number 305, an SRS resource set may include one or more resources (e.g., shown as SRS resources), which may include time resources or frequency resources (e.g., a slot, a symbol, a resource block, or a periodicity for the time resources). As used herein, a “set” of SRS resources must include at least one SRS resource but may also include more than one SRS resource. Similarly, a “set” of SRSs must include at least one SRS but may also include more than one SRS.

As shown by reference number 310, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a network node 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a network node 110 indicates an uplink precoder to the UE 120. For example, when the network node 110 is configured to indicate an uplink precoder to the UE 120 (e.g., using a precoder codebook), the network node 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the network node 110). In some aspects, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the network node 110 indicated an uplink precoder to be used by the UE 120). For example, when the UE 120 is configured to select an uplink precoder, the network node 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the network node 110). A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occur every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI) or a MAC-CE.

In some aspects, the UE 120 may be configured with a mapping between SRS ports (e.g., antenna ports) and corresponding SRS resources. The UE 120 may transmit an SRS on a particular SRS resource using an SRS port indicated in the configuration. In some aspects, an SRS resource may span N adjacent symbols within a slot (e.g., where N equals 1, 2, or 4). The UE 120 may be configured with X SRS ports (e.g., where X ≤ 4). In some aspects, each of the X SRS ports may mapped to a corresponding symbol of the SRS resource and used for transmission of an SRS in that symbol. As used herein, a “set” of SRS ports must include at least one SRS port but may also include more than one SRS port. Generally, a set of SRS ports will be associated with an SRS resource and will consist of one SRS port or two SRS ports.

As shown in FIG. 3, in some aspects, different SRS resource sets indicated to the UE 120 (e.g., having different use cases) may overlap (e.g., in time or in frequency, such as in the same slot). For example, as shown by reference number 315, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 320, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

Some SRS ports may be associated with reception-only antennas (or antenna arrays). Accordingly, SRS resources associated with such SRS ports generally experience imbalance caused by IL. In order to improve channel estimation performed (e.g., by the network node 110) using measurements on SRS resources that are associated with SRS ports that include IL, the UE 120 may compensate for the IL and inform the network node 110 accordingly, as described herein. Additionally, or alternatively, the UE 120 may indicate (to the network node 110) a difference in transmit power for some SRS resources (or SRS ports) caused by the IL, as described herein.

As indicated above, FIG. 3 is provided as an example. Other examples may differ from what is described with regard to FIG. 3.

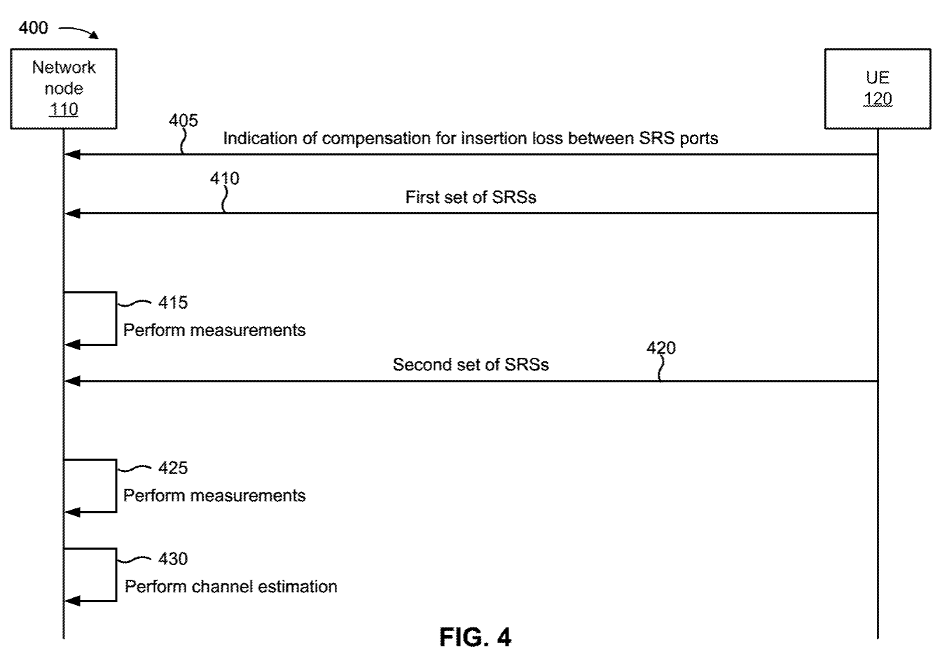

FIG. 4 is a diagram illustrating an example 400 associated with indicating compensation for insertion loss between SRS ports. As shown in FIG. 4, a network node 110 (e.g., an RU 240 or a device controlling the RU 240, such as a DU 230 or a CU 210, among other examples) and a UE 120 may communicate with one another (e.g., OTA within a wireless network, such as wireless communication network 100 of FIG. 1).

As shown by reference number 405, the UE 120 may transmit, and the network node 110 may receive (e.g., directly or via the RU 240), an indication of compensation for insertion loss between SRS ports. The indication may include at least one bit indicating whether the UE fully compensates for IL, partially compensates for IL, or refrains from compensating for IL. In some aspects, the indication may further include more details, such as which SRS ports are adjusted in order to compensate for IL (as compared with which SRS ports are not adjusted to compensate for IL).

In one example, the indication may be included in a UE assistance information (UAI) message. Accordingly, the UE 120 may perform a random access procedure with the network node 110 (e.g., directly or via the RU 240). In response to the random access procedure, the network node 110 may transmit (e.g., directly or via the RU 240), and the UE 120 may receive, an RRC reconfiguration message. Accordingly, the UE 120 may transmit, and the network node 110 may receive (e.g., directly or via the RU 240), the UAI message (including the indication of compensation for insertion loss between SRS ports) in response to the RRC reconfiguration message.

In another example, the indication may be included in a MAC-CE. Accordingly, the UE 120 may transmit, and the network node 110 may receive (e.g., directly or via the RU 240), a power headroom report that includes the indication of compensation for insertion loss between SRS ports.

As shown by reference number 410, the UE 120 may transmit a first set of SRSs using a first set of SRS resources. For example, the UE 120 may transmit in the first set of SRS resources using a first set of SRS ports. The first set of SRS ports may consist of one SRS port or two SRS ports.

As shown by reference number 415, the network node 110 may perform measurements (e.g., directly or via the RU 240) on the first set of SRSs. For example, the network node 110 may perform measurements on the first set of SRS resources (which are associated with the first set of SRS ports).

As shown by reference number 420, the UE 120 may transmit a second set of SRSs using a second set of SRS resources. For example, the UE 120 may transmit in the second set of SRS resources using a second set of SRS ports. The second set of SRS ports may consist of one SRS port or two SRS ports. The UE 120 may compensate for IL across the sets of SRS ports. For example, the UE 120 may adjust a transmit power associated with the second set of SRS ports to match a transmit power associated with the first set of SRS ports.

In some aspects, the UE 120 may further adjust the transmit power associated with the second set of SRS ports based at least in part on a noise FIGURE(NF) associated with the second set of SRS ports. The NF may be caused by one or more passive components before an amplifier (e.g., a low-noise amplifier (LNA)) used for the second set of SRS ports.

As shown by reference number 425, the network node 110 may perform measurements (e.g., directly or via the RU 240) on the second set of SRSs. For example, the network node 110 may perform measurements on the second set of SRS resources (which are associated with the second set of SRS ports).

Although the example 400 is described in connection with two sets of SRS resources, other examples may include more than two sets, such as three sets of SRS resources, four sets of SRS resources, and so on. Accordingly, the UE 120 may compensate for IL in any set of SRS resources associated with SRS ports that experience IL.

As shown by reference number 430, the network node 110 may perform channel estimation using the measurements. Additionally, based at least in part on the indication from the UE 120, the network node 110 may perform channel estimation assuming that the transmit power associated with the second set of SRS ports was adjusted to match a transmit power associated with the first set of SRS ports.

By using techniques as described in connection with FIG. 4, accuracy of the channel estimation is improved because the network node 110 is aware of whether the UE 120 is fully (or partially or not) compensating for IL across SRS ports. Therefore, the network node 110 may increase throughput to the UE 120 based at least in part on the channel estimation, which reduces network overhead.

As indicated above, FIG. 4 is provided as an example. Other examples may differ from what is described with respect to FIG. 4.

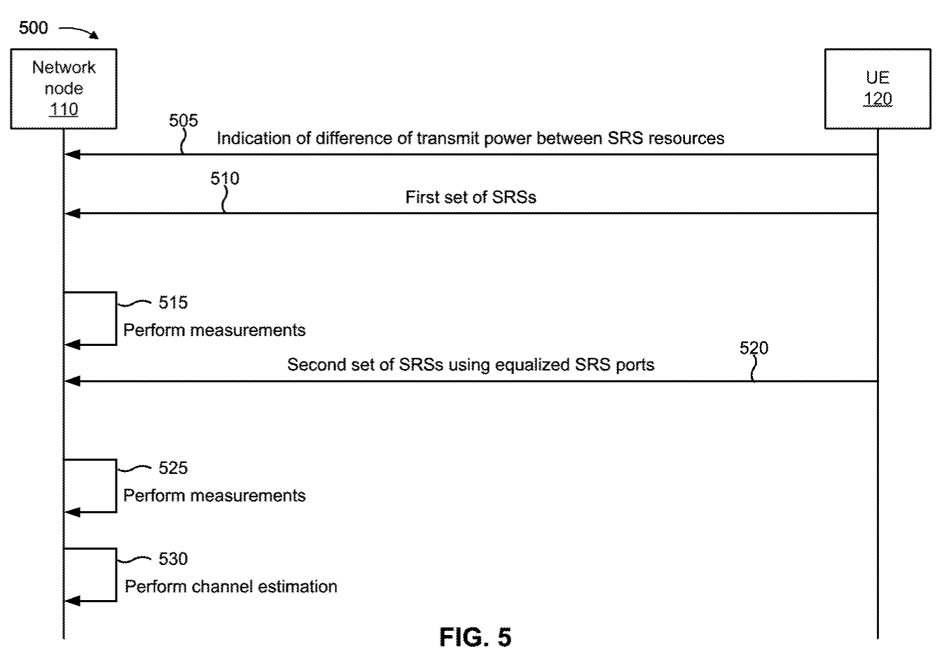

FIG. 5 is a diagram illustrating an example 500 associated with power equalization within an SRS resource. As shown in FIG. 5, a network node 110 (e.g., an RU 240 or a device controlling the RU 240, such as a DU 230 or a CU 210, among other examples) and a UE 120 may communicate with one another (e.g., OTA within a wireless network, such as wireless communication network 100 of FIG. 1).

As shown by reference number 505, the UE 120 may transmit, and the network node 110 may receive (e.g., directly or via the RU 240), an indication of a difference between a transmit power associated with a first SRS resource and a transmit power associated with a second SRS resource. For example, the first SRS resource may be associated with a transmit power of 22 dBm, and the second SRS resource may be associated with a transmit power of 18 dBm, so the UE 120 may report a difference of 4 dBm. Each SRS resource may be associated with one SRS port or two SRS ports.

In one example, the indication may be included in a MAC-CE. Accordingly, the UE 120 may transmit, and the network node 110 may receive (e.g., directly or via the RU 240), a power headroom report that indicates the difference.

As shown by reference number 510, the UE 120 may transmit a first set of SRSs using the first SRS resource. For example, the UE 120 may transmit in the first SRS resource. The first SRS resource may be associated with one SRS port or two SRS ports.

As shown by reference number 515, the network node 110 may perform measurements (e.g., directly or via the RU 240) on the first set of SRSs. For example, the network node 110 may perform measurements on the first SRS resource.

As shown by reference number 520, the UE 120 may transmit a second set of SRSs using the second SRS resource. For example, the UE 120 may transmit in the second SRS resource. The second SRS resource may be associated with two SRS ports (e.g., a first SRS port and a second SRS port). The UE 120 may equalize transmit powers within the second SRS resource. For example, the UE 120 may adjust a transmit power associated with the second SRS port to match a transmit power associated with the first SRS port.

As shown by reference number 525, the network node 110 may perform measurements (e.g., directly or via the RU 240) on the second set of SRSs. For example, the network node 110 may perform measurements on the second SRS resource.

Although the example 500 is described in connection with two SRS resources, other examples may include more than two SRS resources, such as three SRS resources, four SRS resources, and so on. Accordingly, the UE 120 may equalize transmit power across SRS ports within any single SRS resource.

As shown by reference number 530, the network node 110 may perform channel estimation using the measurements. Additionally, based at least in part on the indication from the UE 120, the network node 110 may perform channel estimation using the difference in transmit powers between SRS resources.

By using techniques as described in connection with FIG. 5, accuracy of the channel estimation is improved because the UE 120 reports transmit power differences across SRS resources (e.g., caused by IL). Therefore, the network node 110 may increase throughput to the UE 120 based at least in part on the channel estimation, which reduces network overhead.

As indicated above, FIG. 5 is provided as an example. Other examples may differ from what is described with respect to FIG. 5.

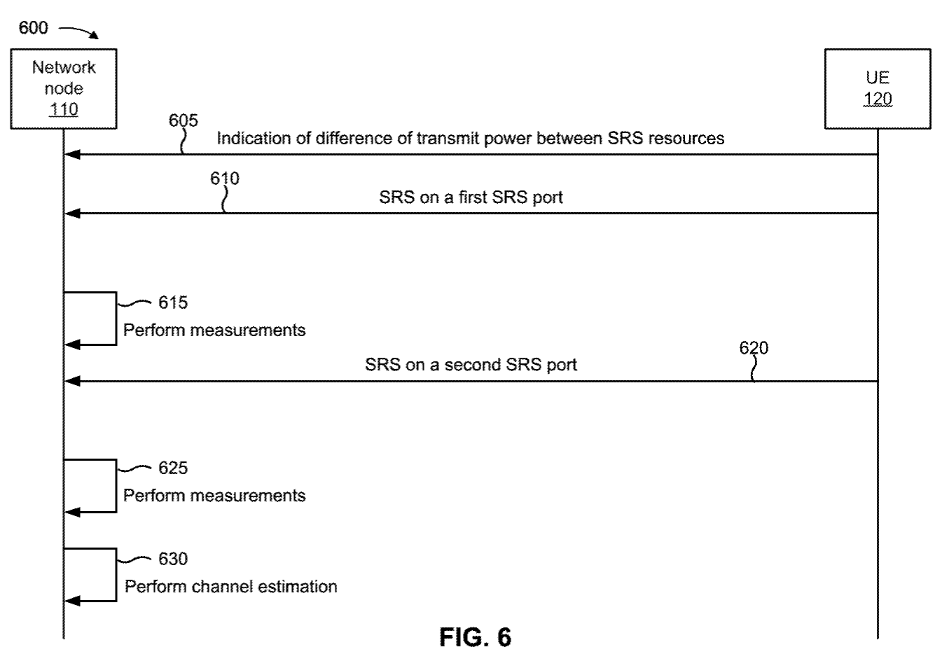

FIG. 6 is a diagram illustrating an example 600 associated with reporting power differences between SRS ports. As shown in FIG. 6, a network node 110 (e.g., an RU 240 or a device controlling the RU 240, such as a DU 230 or a CU 210, among other examples) and a UE 120 may communicate with one another (e.g., OTA within a wireless network, such as wireless communication network 100 of FIG. 1).

As shown by reference number 605, the UE 120 may transmit, and the network node 110 may receive (e.g., directly or via the RU 240), an indication of a difference between a transmit power associated with a reference SRS resource (or a reference SRS port) and a transmit power associated with a first SRS port, and a difference between the transmit power associated with the reference SRS resource (or the reference SRS port) and a transmit power associated with a second SRS port. For example, the reference SRS resource (or the reference SRS port) may be associated with a transmit power of 23 dBm, the first SRS port may be associated with a transmit power of 22 dBm, and the second SRS port may be associated with a transmit power of 18 dBm, so the UE 120 may report a difference of 1 dBm between the reference and the first SRS port and a difference of 5 dBm between the reference and the second SRS port.

In one example, the indication may be included in a MAC-CE. Accordingly, the UE 120 may transmit, and the network node 110 may receive (e.g., directly or via the RU 240), a power headroom report that indicates the differences.

In some aspects, the UE 120 may further report an NF associated with each SRS port. For example, the indication may include a first NF associated with the first SRS port and a second NF associated with the second SRS port.

As shown by reference number 610, the UE 120 may transmit an SRS on the first SRS port. For example, the UE 120 may transmit in an SRS resource associated with the first SRS port.

As shown by reference number 615, the network node 110 may perform measurements (e.g., directly or via the RU 240) on the SRS associated with the first SRS port. For example, the network node 110 may perform measurements on the SRS resource associated with the first SRS port.

As shown by reference number 620, the UE 120 may transmit an SRS on the second SRS port. For example, the UE 120 may transmit in an SRS resource associated with the second SRS port. The transmit power associated with the first SRS port may be independent of the transmit power associated with the second SRS port. For example, the first and second SRS ports may be associated with a same SRS resource, and the UE 120 may refrain from splitting a transmit power associated with the SRS resource across the first and second SRS ports.

As shown by reference number 625, the network node 110 may perform measurements (e.g., directly or via the RU 240) on the SRS associated with the second SRS port. For example, the network node 110 may perform measurements on the SRS resource associated with the second SRS port.

Although the example 600 is described in connection with a single SRS resource, other examples may include more SRS resources, such as two SRS resources, three SRS resources, and so on. Accordingly, the UE 120 may report differences in transmit power for each SRS port, relative to the transmit power for the reference SRS resource (or the reference SRS port), associated with any additional SRS resources.

As shown by reference number 630, the network node 110 may perform channel estimation using the measurements. Additionally, based at least in part on the indication from the UE 120, the network node 110 may perform channel estimation using the difference in transmit powers between SRS ports. For example, the network node 110 may perform channel estimation assuming that a transmit power associated with the first SRS port is independent of the transmit power associated with the second SRS port.

By using techniques as described in connection with FIG. 6, accuracy of the channel estimation is improved because the UE 120 reports transmit power differences across SRS ports (e.g., caused by IL). Therefore, the network node 110 may increase throughput to the UE 120 based at least in part on the channel estimation, which reduces network overhead.

As indicated above, FIG. 6 is provided as an example. Other examples may differ from what is described with respect to FIG. 6.

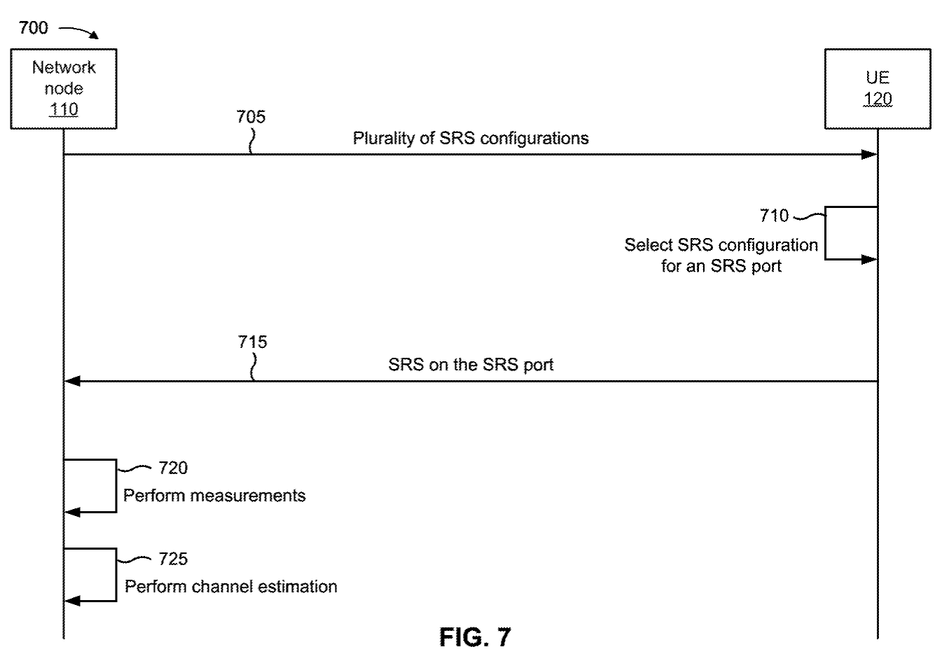

FIG. 7 is a diagram illustrating an example 700 associated with using power differences to choose between SRS configurations. As shown in FIG. 7, a network node 110 (e.g., an RU 240 or a device controlling the RU 240, such as a DU 230 or a CU 210, among other examples) and a UE 120 may communicate with one another (e.g., OTA within a wireless network, such as wireless communication network 100 of FIG. 1).

As shown by reference number 705, the network node 110 may transmit (e.g., directly or via the RU 240), and the UE 120 may receive, a plurality of SRS configurations for an SRS port. For example, the plurality of SRS configurations may be included in an RRC message (or a plurality of RRC messages). Each SRS configuration may be associated with a different transmit power differential, relative to a reference SRS port (or reference SRS resource). For example, a first SRS configuration may be associated with a differential of 4 dBm, a second SRS configuration may be associated with a differential of 5 dBm, and a third SRS configuration may be associated with a differential of 6 dBm.

As shown by reference number 710, the UE 120 may select an SRS configuration (from the plurality of SRS configurations) for the SRS port. The UE 120 may determine a selected SRS configuration (from the plurality of SRS configurations) using a difference between a transmit power associated with the reference SRS port (or the reference SRS resource) and a transmit power associated with the SRS port. For example, if the SRS port is associated with a difference in transmit power of 5 dBm relative to the transmit power of the reference SRS port (or the reference SRS resource), the UE 120 may select the second SRS configuration for the SRS port.

In some aspects, the UE 120 may further determine the selected SRS configuration using an NF associated with the SRS port. For example, if the SRS port is further associated with an NF of 1 dBm, the UE 120 may select the third SRS configuration for the SRS port (to account for the difference in transmit power as well as the NF).

As shown by reference number 715, the UE 120 may transmit an SRS on the SRS port. For example, the UE 120 may transmit using the SRS port and the selected SRS configuration.

As shown by reference number 720, the network node 110 may perform measurements (e.g., directly or via the RU 240) on the SRS associated with the SRS port. For example, the network node 110 may perform measurements on an SRS resource associated with the SRS port.

Although the example 700 is described in connection with a single SRS port, other examples may include more SRS ports, such as two SRS ports, three SRS ports, and so on. Accordingly, the UE 120 may select an SRS configuration for each SRS port, using a difference in transmit power for the SRS port relative to the transmit power for the reference SRS port (or the reference SRS resource).

As shown by reference number 725, the network node 110 may perform channel estimation using the measurements. Additionally, the measurements may indicate the selected SRS configuration, from which the network node 110 may infer the difference between the transmit power associated with the reference SRS port (or the reference SRS resource) and the transmit power associated with the SRS port. Accordingly, the network node 110 may perform channel estimation using the difference in transmit powers.

By using techniques as described in connection with FIG. 7, accuracy of the channel estimation is improved because the network node 110 may infer transmit power differences across SRS ports (e.g., caused by IL). Therefore, the network node 110 may increase throughput to the UE 120 based at least in part on the channel estimation, which reduces network overhead.

As indicated above, FIG. 7 is provided as an example. Other examples may differ from what is described with respect to FIG. 7.

FIG. 8 is a diagram illustrating an example process 800 performed, for example, at a UE or an apparatus of a UE. Example process 800 is an example where the apparatus or the UE (e.g., UE 120) performs operations associated with indications of compensation for IL between SRS ports.

As shown in FIG. 8, in some aspects, process 800 may include transmitting an indication of compensation for insertion loss between SRS ports (block 810). For example, the UE (e.g., using transmission component 1504 or communication manager 1506, depicted in FIG. 15) may transmit an indication of compensation for insertion loss between SRS ports, as described herein.

As further shown in FIG. 8, in some aspects, process 800 may include transmitting in a first set of SRS resources using a first set of SRS ports (block 820). For example, the UE (e.g., using transmission component 1504 or communication manager 1506) may transmit in a first set of SRS resources using a first set of SRS ports, as described herein.

As further shown in FIG. 8, in some aspects, process 800 may include transmitting in a second set of SRS resources using a second set of SRS ports, where each set of SRS ports consists of one SRS port or two SRS ports, and where a transmit power associated with the second set of SRS ports is adjusted to match a transmit power associated with the first set of SRS ports (block 830). For example, the UE (e.g., using transmission component 1504 or communication manager 1506) may transmit in a second set of SRS resources using a second set of SRS ports, where each set of SRS ports consists of one SRS port or two SRS ports, and where a transmit power associated with the second set of SRS ports is adjusted to match a transmit power associated with the first set of SRS ports, as described herein.

Process 800 may include additional aspects, such as any single aspect or any combination of aspects described below or in connection with one or more other processes described elsewhere herein.

In a first aspect, the indication includes a UAI message.

In a second aspect, alone or in combination with the first aspect, process 800 includes performing a random access procedure (e.g., using reception component 1502, transmission component 1504, and communication manager 1506, depicted in FIG. 15), and receiving an RRC reconfiguration message (e.g., using reception component 1502 or communication manager 1506) in response to the random access procedure, where the indication of compensation for insertion loss is transmitted in response to the RRC reconfiguration message.

In a third aspect, alone or in combination with one or more of the first and second aspects, the indication includes a power headroom report.

In a fourth aspect, alone or in combination with one or more of the first through third aspects, the indication is associated with full compensation of the insertion loss.

In a fifth aspect, alone or in combination with one or more of the first through fourth aspects, the indication is associated with no or partial compensation of the insertion loss.

In a sixth aspect, alone or in combination with one or more of the first through fifth aspects, the transmit power associated with the second set of SRS ports is further adjusted based at least in part on a noise figure associated with the second set of SRS ports.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with indications of compensation for IL between SRS ports.

As shown in FIG. 9, in some aspects, process 900 may include receiving an indication of compensation for insertion loss between SRS ports of a UE (block 910). For example, the network node (e.g., using reception component 1602 or communication manager 1606, depicted in FIG. 16) may receive an indication of compensation for insertion loss between SRS ports of a UE, as described herein.

As further shown in FIG. 9, in some aspects, process 900 may include performing measurements on a first set of SRS resources associated with a first set of SRS ports and on a second set of SRS resources associated with a second set of SRS ports, where each set of SRS ports consists of one SRS port or two SRS ports (block 920). For example, the network node (e.g., using reception component 1602 or communication manager 1606) may perform measurements on a first set of SRS resources associated with a first set of SRS ports and on a second set of SRS resources associated with a second set of SRS ports, where each set of SRS ports consists of one SRS port or two SRS ports, as described herein.

As further shown in FIG. 9, in some aspects, process 900 may include performing channel estimation using the measurements and assuming a transmit power associated with the second set of SRS ports was adjusted to match a transmit power associated with the first set of SRS ports (block 930). For example, the network node (e.g., using communication manager 1606) may perform channel estimation using the measurements and assuming a transmit power associated with the second set of SRS ports was adjusted to match a transmit power associated with the first set of SRS ports, as described herein.

Process 900 may include additional aspects, such as any single aspect or any combination of aspects described below or in connection with one or more other processes described elsewhere herein.

In a first aspect, the indication includes a UAI message.

In a second aspect, alone or in combination with the first aspect, process 900 includes performing a random access procedure with the UE (e.g., using reception component 1602, transmission component 1604, and communication manager 1606), and transmitting an RRC reconfiguration message (e.g., using transmission component 1604 or communication manager 1606) in response to the random access procedure, where the indication of compensation for insertion loss is received in response to the RRC reconfiguration message.

In a third aspect, alone or in combination with one or more of the first and second aspects, the indication includes a power headroom report.

In a fourth aspect, alone or in combination with one or more of the first through third aspects, the indication is associated with full compensation of the insertion loss.

In a fifth aspect, alone or in combination with one or more of the first through fourth aspects, the indication is associated with no or partial compensation of the insertion loss.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE. Example process 1000 is an example where the apparatus or the UE (e.g., UE 120) performs operations associated with equalizing transmit power between SRS ports associated with a same SRS resource.

As shown in FIG. 10, in some aspects, process 1000 may include transmitting an indication of a difference between a transmit power associated with a first SRS resource and a transmit power associated with a second SRS resource, where the second SRS resource is associated with a first SRS port and a second SRS port (block 1010). For example, the UE (e.g., using transmission component 1504 or communication manager 1506, depicted in FIG. 15) may transmit an indication of a difference between a transmit power associated with a first SRS resource and a transmit power associated with a second SRS resource, where the second SRS resource is associated with a first SRS port and a second SRS port, as described herein.

As further shown in FIG. 10, in some aspects, process 1000 may include transmitting a set of SRSs using the second SRS resource, where a transmit power associated with the second SRS port is adjusted to match a transmit power associated with the first SRS port (block 1020). For example, the UE (e.g., using transmission component 1504 or communication manager 1506) may transmit a set of SRSs using the second SRS resource, where a transmit power associated with the second SRS port is adjusted to match a transmit power associated with the first SRS port, as described herein.

Process 1000 may include additional aspects, such as any single aspect or any combination of aspects described below or in connection with one or more other processes described elsewhere herein.

In a first aspect, the transmit power associated with the second SRS port is reduced to match the transmit power associated with the first SRS port.

In a second aspect, alone or in combination with the first aspect, the transmit power associated with the second SRS port is increased to match the transmit power associated with the first SRS port.

In a third aspect, alone or in combination with one or more of the first and second aspects, the indication includes a MAC-CE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UE or an apparatus of a UE. Example process 1100 is an example where the apparatus or the UE (e.g., UE 120) performs operations associated with indicating transmit power differences between SRS ports.

As shown in FIG. 11, in some aspects, process 1100 may include transmitting an indication of a difference between a transmit power associated with a reference SRS resource and a transmit power associated with a first SRS port, and a difference between the transmit power associated with the reference SRS resource and a transmit power associated with a second SRS port (block 1110). For example, the UE (e.g., using transmission component 1504 or communication manager 1506, depicted in FIG. 15) may transmit an indication of a difference between a transmit power associated with a reference SRS resource and a transmit power associated with a first SRS port, and a difference between the transmit power associated with the reference SRS resource and a transmit power associated with a second SRS port, as described herein.

As further shown in FIG. 11, in some aspects, process 1100 may include transmitting a set of SRSs using an SRS resource associated with the first SRS port and the second SRS port, where the transmit power associated with the first SRS port is independent of the transmit power associated with the second SRS port (block 1120). For example, the UE (e.g., using transmission component 1504 or communication manager 1506) may transmit a set of SRSs using an SRS resource associated with the first SRS port and the second SRS port, where the transmit power associated with the first SRS port is independent of the transmit power associated with the second SRS port, as described herein.

Process 1100 may include additional aspects, such as any single aspect or any combination of aspects described below or in connection with one or more other processes described elsewhere herein.

In a first aspect, the indication includes a MAC-CE.

In a second aspect, alone or in combination with the first aspect, the indication further indicates a first noise figure associated with the first SRS port or a second noise figure associated with the second SRS port.

In a third aspect, alone or in combination with one or more of the first and second aspects, the transmit power associated with the second SRS port is further adjusted based at least in part on a noise figure associated with the second SRS port.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node. Example process 1200 is an example where the apparatus or the network node (e.g., network node 110) performs operations associated with indicating transmit power differences between SRS ports.

As shown in FIG. 12, in some aspects, process 1200 may include receiving an indication of a difference between a transmit power associated with a reference SRS resource and a transmit power associated with a first SRS port, and a difference between the transmit power associated with the reference SRS resource and a transmit power associated with a second SRS port (block 1210). For example, the network node (e.g., using reception component 1602 or communication manager 1606, depicted in FIG. 16) may receive an indication of a difference between a transmit power associated with a reference SRS resource and a transmit power associated with a first SRS port, and a difference between the transmit power associated with the reference SRS resource and a transmit power associated with a second SRS port, as described herein.

As further shown in FIG. 12, in some aspects, process 1200 may include performing measurements using an SRS resource associated with the first SRS port and the second SRS port (block 1220). For example, the network node (e.g., using reception component 1602 or communication manager 1606) may perform measurements using an SRS resource associated with the first SRS port and the second SRS port, as described herein.

As further shown in FIG. 12, in some aspects, process 1200 may include performing channel estimation using the measurements and assuming a transmit power associated with the first SRS port is independent of the transmit power associated with the second SRS port (block 1230). For example, the network node (e.g., using communication manager 1606) may perform channel estimation using the measurements and assuming a transmit power associated with the first SRS port is independent of the transmit power associated with the second SRS port, as described herein.

Process 1200 may include additional aspects, such as any single aspect or any combination of aspects described below or in connection with one or more other processes described elsewhere herein.

In a first aspect, the indication includes a MAC-CE.

In a second aspect, alone or in combination with the first aspect, the indication further indicates a noise figure associated with the first SRS port or a noise figure associated with the second SRS port.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a UE or an apparatus of a UE. Example process 1300 is an example where the apparatus or the UE (e.g., UE 120) performs operations associated with selecting from multiple SRS configurations.

As shown in FIG. 13, in some aspects, process 1300 may include receiving a plurality of SRS configurations for an SRS port (block 1310). For example, the UE (e.g., using reception component 1502 or communication manager 1506, depicted in FIG. 15) may receive a plurality of SRS configurations for an SRS port, as described herein.

As further shown in FIG. 13, in some aspects, process 1300 may include transmitting using the SRS port and a selected SRS configuration from the plurality of SRS configurations, where the selected SRS configuration is determined using a difference between a transmit power associated with a reference SRS port and a transmit power associated with the SRS port (block 1320). For example, the UE (e.g., using transmission component 1504 or communication manager 1506, depicted in FIG. 15) may transmit using the SRS port and a selected SRS configuration from the plurality of SRS configurations, where the selected SRS configuration is determined using a difference between a transmit power associated with a reference SRS port and a transmit power associated with the SRS port, as described herein.

Process 1300 may include additional aspects, such as any single aspect or any combination of aspects described below or in connection with one or more other processes described elsewhere herein.

In a first aspect, the selected SRS configuration is further determined using a noise figure associated with the SRS port.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node. Example process 1400 is an example where the apparatus or the network node (e.g., network node 110) performs operations associated with selecting from multiple SRS configurations.

As shown in FIG. 14, in some aspects, process 1400 may include transmitting a plurality of SRS configurations for an SRS port (block 1410). For example, the network node (e.g., using transmission component 1604 or communication manager 1606, depicted in FIG. 16) may transmit a plurality of SRS configurations for an SRS port, as described herein.

As further shown in FIG. 14, in some aspects, process 1400 may include performing measurements using an SRS resource associated with the SRS port (block 1420). For example, the network node (e.g., using reception component 1602 or communication manager 1606, depicted in FIG. 16) may perform measurements using an SRS resource associated with the SRS port, as described herein.

As further shown in FIG. 14, in some aspects, process 1400 may include performing channel estimation using the measurements and a selected SRS configuration, from the plurality of SRS configurations, that indicates a difference between a transmit power associated with a reference SRS port and a transmit power associated with the SRS port (block 1430). For example, the network node (e.g., using communication manager 1606) may perform channel estimation using the measurements and a selected SRS configuration, from the plurality of SRS configurations, that indicates a difference between a transmit power associated with a reference SRS port and a transmit power associated with the SRS port, as described herein.

Process 1400 may include additional aspects, such as any single aspect or any combination of aspects described below or in connection with one or more other processes described elsewhere herein.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE, or a UE may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 140 described in connection with FIG. 1) of the UE.

In some aspects, the apparatus 1500 may be configured to perform one or more operations described herein in connection with FIGS. 4-7. Additionally, or alternatively, the apparatus 1500 may be configured to perform one or more processes described herein, such as process 800 of FIG. 8, process 1000 of FIG. 10, process 1100 of FIG. 11, process 1300 of FIG. 13, or a combination thereof. In some aspects, the apparatus 1500 or one or more components shown in FIG. 15 may include one or more components of the UE described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the UE described above in connection with FIG. 1, such as a radio, one or more RF chains, one or more transceivers, or one or more modems, each of which may in turn be coupled with one or more antennas of the UE.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

In some aspects, the transmission component 1504 may transmit (e.g., to the apparatus 1508, such as a network node) an indication of compensation for insertion loss between SRS ports. The transmission component 1504 additionally may transmit (e.g., to the apparatus 1508) in a first set of SRS resources using a first set of SRS ports and may transmit (e.g., to the apparatus 1508) in a second set of SRS resources using a second set of SRS ports. Each set of SRS ports may consist of one SRS port or two SRS ports, and a transmit power associated with the second set of SRS ports may be adjusted to match a transmit power associated with the first set of SRS ports. In some aspects, the reception component 1502, the transmission component 1504, and the communication manager 1506 may perform a random access procedure (e.g., with the apparatus 1508), and the reception component 1502 may receive an RRC reconfiguration message in response to the random access procedure. Accordingly, the transmission component 1504 may transmit the indication of compensation for insertion loss in response to the RRC reconfiguration message.

In some aspects, the transmission component 1504 may transmit (e.g., to the apparatus 1508, such as a network node) an indication of a difference between a transmit power associated with a first SRS resource and a transmit power associated with a second SRS resource. The second SRS resource may be associated with a first SRS port and a second SRS port. The transmission component 1504 may transmit (e.g., to the apparatus 1508) a set of SRSs using the second SRS resource, and a transmit power associated with the second SRS port may be adjusted to match a transmit power associated with the first SRS port.

In some aspects, the transmission component 1504 may transmit (e.g., to the apparatus 1508, such as a network node) an indication of a difference between a transmit power associated with a reference SRS resource and a transmit power associated with a first SRS port, and a difference between the transmit power associated with the reference SRS resource and a transmit power associated with a second SRS port. The transmission component 1504 may transmit (e.g., to the apparatus 1508) a set of SRSs using an SRS resource associated with the first SRS port and the second SRS port, and the transmit power associated with the first SRS port may be independent of the transmit power associated with the second SRS port.

In some aspects, the reception component 1502 may receive (e.g., from the apparatus 1508, such as a network node) a plurality of SRS configurations for an SRS port. The transmission component 1504 may transmit (e.g., to the apparatus 1508) using the SRS port and a selected SRS configuration from the plurality of SRS configurations. The selected SRS configuration may be determined using a difference between a transmit power associated with a reference SRS port and a transmit power associated with the SRS port.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a network node, or a network node may include the apparatus 1600. In some aspects, the apparatus 1600 includes a reception component 1602, a transmission component 1604, or a communication manager 1606, which may be in communication with one another (for example, via one or more buses or one or more other components). In some aspects, the communication manager 1606 is the communication manager 155 described in connection with FIG. 1. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system (for example, the processing system 145 described in connection with FIG. 1) of the network node.

In some aspects, the apparatus 1600 may be configured to perform one or more operations described herein in connection with FIGS. 4-7. Additionally, or alternatively, the apparatus 1600 may be configured to perform one or more processes described herein, such as process 900 of FIG. 9, process 1200 of FIG. 12, process 1400 of FIG. 14, or a combination thereof. In some aspects, the apparatus 1600 or one or more components shown in FIG. 16 may include one or more components of the network node described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the network node described above in connection with FIG. 1, such as a radio, one or more RF chains, one or more transceivers, or one or more modems, each of which may in turn be coupled with one or more antennas of the network node. In some aspects, the reception component 1602 or the transmission component 1604 may include or may be included in a network interface. The network interface may be configured to obtain or output signals for the apparatus 1600 via one or more communications links, such as a backhaul link, a midhaul link, or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1604 may be co-located with the reception component 1602.

The communication manager 1606 may support operations of the reception component 1602 or the transmission component 1604. For example, the communication manager 1606 may receive information associated with configuring reception of communications by the reception component 1602 or transmission of communications by the transmission component 1604. Additionally, or alternatively, the communication manager 1606 may generate or provide control information to the reception component 1602 or the transmission component 1604 to control reception or transmission of communications.

In some aspects, the reception component 1602 may receive (e.g., from the apparatus 1608, such as a UE) an indication of compensation for insertion loss between SRS ports. The reception component 1602 or the communication manager 1606 may perform measurements on a first set of SRS resources associated with a first set of SRS ports and on a second set of SRS resources associated with a second set of SRS ports. Each set of SRS ports may consist of one SRS port or two SRS ports, and the communication manager 1606 may perform channel estimation using the measurements and assuming a transmit power associated with the second set of SRS ports was adjusted to match a transmit power associated with the first set of SRS ports. In some aspects, the reception component 1602, the transmission component 1604, and the communication manager 1606 may perform a random access procedure (e.g., with the apparatus 1608). The transmission component 1604 may transmit (e.g., to the apparatus 1608) an RRC reconfiguration message in response to the random access procedure, and the reception component 1602 may receive the indication of compensation for insertion loss in response to the RRC reconfiguration message.

In some aspects, the reception component 1602 may receive (e.g., from the apparatus 1608, such as a UE) an indication of a difference between a transmit power associated with a reference SRS resource and a transmit power associated with a first SRS port, and a difference between the transmit power associated with the reference SRS resource and a transmit power associated with a second SRS port. The reception component 1602 or the communication manager 1606 may perform measurements using an SRS resource associated with the first SRS port and the second SRS port. The communication manager 1606 may perform channel estimation using the measurements and assuming a transmit power associated with the first SRS port is independent of the transmit power associated with the second SRS port.

In some aspects, the transmission component 1604 may transmit (e.g., to the apparatus 1608, such as a UE) a plurality of SRS configurations for an SRS port. The reception component 1602 or the communication manager 1606 may perform measurements using an SRS resource associated with the SRS port. The communication manager 1606 may perform channel estimation using the measurements and a selected SRS configuration, from the plurality of SRS configurations, that indicates a difference between a transmit power associated with a reference SRS port and a transmit power associated with the SRS port.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: transmitting, by the UE, an indication of compensation for insertion loss between sounding reference signal (SRS) ports; transmitting, by the UE, in a first set of SRS resources using a first set of SRS ports; and transmitting, by the UE, in a second set of SRS resources using a second set of SRS ports, wherein each set of SRS ports consists of one SRS port or two SRS ports, and wherein a transmit power associated with the second set of SRS ports is adjusted to match a transmit power associated with the first set of SRS ports.

Aspect 2: The method of Aspect 1, wherein the indication comprises a UE assistance information message.

Aspect 3: The method of any of Aspects 1-2, further comprising: performing, by the UE, a random access procedure; and receiving, by the UE, a radio resource control (RRC) reconfiguration message in response to the random access procedure, wherein the indication of compensation for insertion loss is transmitted in response to the RRC reconfiguration message.

Aspect 4: The method of any of Aspects 1-3, wherein the indication comprises a power headroom report.

Aspect 5: The method of any of Aspects 1-4, wherein the indication is associated with full compensation of the insertion loss.

Aspect 6: The method of any of Aspects 1-4, wherein the indication is associated with no or partial compensation of the insertion loss.

Aspect 7: The method of any of Aspects 1-6, wherein the transmit power associated with the second set of SRS ports is further adjusted based at least in part on a noise figure associated with the second set of SRS ports.

Aspect 8: A method of wireless communication performed by a network node, comprising: receiving, by the network node, an indication of compensation for insertion loss between sounding reference signal (SRS) ports of a user equipment (UE); performing measurements, by the network node, on a first set of SRS resources associated with a first set of SRS ports and on a second set of SRS resources associated with a second set of SRS ports, wherein each set of SRS ports consists of one SRS port or two SRS ports; and performing channel estimation, by the network node, using the measurements and assuming a transmit power associated with the second set of SRS ports was adjusted to match a transmit power associated with the first set of SRS ports.

Aspect 9: The method of Aspect 8, wherein the indication comprises a UE assistance information message.

Aspect 10: The method of any of Aspects 8-9, further comprising: performing, by the network node, a random access procedure with the UE; and transmitting, by the network node, a radio resource control (RRC) reconfiguration message in response to the random access procedure, wherein the indication of compensation for insertion loss is received in response to the RRC reconfiguration message.

Aspect 11: The method of any of Aspects 8-10, wherein the indication comprises a power headroom report.

Aspect 12: The method of any of Aspects 8-11, wherein the indication is associated with full compensation of the insertion loss.

Aspect 13: The method of any of Aspects 8-11, wherein the indication is associated with no or partial compensation of the insertion loss.

Aspect 14: A method of wireless communication performed by a user equipment (UE), comprising: transmitting, by the UE, an indication of a difference between a transmit power associated with a first sounding reference signal (SRS) resource and a transmit power associated with a second SRS resource, wherein the second SRS resource is associated with a first SRS port and a second SRS port; and transmitting, by the UE, a set of SRSs using the second SRS resource, wherein a transmit power associated with the second SRS port is adjusted to match a transmit power associated with the first SRS port.

Aspect 15: The method of Aspect 14, wherein the transmit power associated with the second SRS port is reduced to match the transmit power associated with the first SRS port.

Aspect 16: The method of Aspect 14, wherein the transmit power associated with the second SRS port is increased to match the transmit power associated with the first SRS port.

Aspect 17: The method of any of Aspects 14-16, wherein the indication comprises a medium access control (MAC) control element (MAC-CE).

Aspect 18: A method of wireless communication performed by a user equipment (UE), comprising: transmitting, by the UE, an indication of a difference between a transmit power associated with a reference sounding reference signal (SRS) resource and a transmit power associated with a first SRS port, and a difference between the transmit power associated with the reference SRS resource and a transmit power associated with a second SRS port; and transmitting, by the UE, a set of SRSs using an SRS resource associated with the first SRS port and the second SRS port, wherein the transmit power associated with the first SRS port is independent of the transmit power associated with the second SRS port.

Aspect 19: The method of Aspect 18, wherein the indication comprises a medium access control (MAC) control element (MAC-CE).

Aspect 20: The method of any of Aspects 18-19, wherein the indication further indicates a first noise figure associated with the first SRS port or a second noise figure associated with the second SRS port.

Aspect 21: The method of any of Aspects 18-20, wherein the transmit power associated with the second SRS port is further adjusted based at least in part on a noise figure associated with the second SRS port.

Aspect 22: A method of wireless communication performed by a network node, comprising: receiving, by the network node, an indication of a difference between a transmit power associated with a reference sounding reference signal (SRS) resource and a transmit power associated with a first SRS port, and a difference between the transmit power associated with the reference SRS resource and a transmit power associated with a second SRS port; performing measurements, by the network node, using an SRS resource associated with the first SRS port and the second SRS port; and performing channel estimation, by the network node, using the measurements and assuming a transmit power associated with the first SRS port is independent of the transmit power associated with the second SRS port.

Aspect 23: The method of Aspect 22, wherein the indication comprises a medium access control (MAC) control element (MAC-CE).

Aspect 24: The method of any of Aspects 22-23, wherein the indication further indicates a noise figure associated with the first SRS port or a noise figure associated with the second SRS port.

Aspect 25: A method of wireless communication performed by a user equipment (UE), comprising: receiving, by the UE, a plurality of sounding reference signal (SRS) configurations for an SRS port; and transmitting, by the UE, using the SRS port and a selected SRS configuration from the plurality of SRS configurations, wherein the selected SRS configuration is determined using a difference between a transmit power associated with a reference SRS port and a transmit power associated with the SRS port.

Aspect 26: The method of Aspect 25, wherein the selected SRS configuration is further determined using a noise figure associated with the SRS port.

Aspect 27: A method of wireless communication performed by a network node, comprising: transmitting, by the network node, a plurality of sounding reference signal (SRS) configurations for an SRS port; performing measurements, by the network node, using an SRS resource associated with the SRS port; and performing channel estimation, by the network node, using the measurements and a selected SRS configuration, from the plurality of SRS configurations, that indicates a difference between a transmit power associated with a reference SRS port and a transmit power associated with the SRS port.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

Aspect 35: A device comprising a processing system that includes one or more processors and one or more code-storing memories coupled with the one or more processors, the processing system configured to cause the device to perform the method of one or more of Aspects 1-27.

Aspect 36: A device comprising a processing system that includes processor circuitry and code-storing memory circuitry, the processing system configured to cause the device to perform the method of one or more of Aspects 1-27.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet, such as data or control signaling. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, the term “A or B” as well as the term “A and/or B” may include A only, B only, or a combination of both A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “based on” is equivalent to “based at least in part on” and indicates a non-limiting relationship between elements “a” and “b.” In some aspects, a’ (which may be a variation or example of a) may be responsive to or in response to b’ (which may be a variation or example of b), such as if condition c is met. In some other aspects, a’’ (which may be a variation or example of at least one of a or a’) may be associated with b’’ (which may be a variation or example of at least one of b or b’). In some further aspects, a’’’ (which may be a variation or example of at least one of a or a’ or a’’) may be determined (or any of the other actions encompassed by usage of the word “determining” as described above) in accordance with b’’’ (which may be a variation or example of at least one of b or b’ or b’’). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products. Additionally, even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, the one or more processors, individually or collectively and based at least in part on information stored in the one or more memories, being configured to:
transmit an indication of compensation for insertion loss between sounding reference signal (SRS) ports;
transmit in a first set of SRS resources using a first set of SRS ports; and
transmit in a second set of SRS resources using a second set of SRS ports,
wherein each set of SRS ports consists of one SRS port or two SRS ports, and
wherein a transmit power associated with the second set of SRS ports is adjusted to match a transmit power associated with the first set of SRS ports.

2. The apparatus of claim 1, wherein the indication comprises a UE assistance information message.

3. The apparatus of claim 1, wherein the one or more processors are, individually or collectively and based at least in part on information stored in the one or more memories, configured to:
perform a random access procedure; and
receive a radio resource control (RRC) reconfiguration message in response to the random access procedure,
wherein the indication of compensation for insertion loss is transmitted in response to the RRC reconfiguration message.

4. The apparatus of claim 1, wherein the indication comprises a power headroom report.

5. The apparatus of claim 1, wherein the indication is associated with full compensation of the insertion loss.

6. The apparatus of claim 1, wherein the indication is associated with no or partial compensation of the insertion loss.

7. The apparatus of claim 1, wherein the transmit power associated with the second set of SRS ports is further adjusted based at least in part on a noise figure associated with the second set of SRS ports.

8. A method of wireless communication performed by a user equipment (UE), comprising:
transmitting an indication of compensation for insertion loss between sounding reference signal (SRS) ports;
transmitting in a first set of SRS resources using a first set of SRS ports; and
transmitting in a second set of SRS resources using a second set of SRS ports,
wherein each set of SRS ports consists of one SRS port or two SRS ports, and
wherein a transmit power associated with the second set of SRS ports is adjusted to match a transmit power associated with the first set of SRS ports.

9. The method of claim 8, wherein the indication comprises a UE assistance information message.

10. The method of claim 8, further comprising:
performing a random access procedure; and
receiving a radio resource control (RRC) reconfiguration message in response to the random access procedure,
wherein the indication of compensation for insertion loss is transmitted in response to the RRC reconfiguration message.

11. The method of claim 8, wherein the indication comprises a power headroom report.

12. The method of claim 8, wherein the indication is associated with full compensation of the insertion loss.

13. The method of claim 8, wherein the indication is associated with no or partial compensation of the insertion loss.

14. The method of claim 8, wherein the transmit power associated with the second set of SRS ports is further adjusted based at least in part on a noise figure associated with the second set of SRS ports.

15. An apparatus for wireless communication at a user equipment (UE), comprising:
one or more memories; and
one or more processors, the one or more processors, individually or collectively and based at least in part on information stored in the one or more memories, being configured to:
transmit an indication of a difference between a transmit power associated with a first sounding reference signal (SRS) resource and a transmit power associated with a second SRS resource, wherein the second SRS resource is associated with a first SRS port and a second SRS port; and
transmit a set of SRSs using the second SRS resource,
wherein a transmit power associated with the second SRS port is adjusted to match a transmit power associated with the first SRS port.

16. The apparatus of claim 15, wherein the transmit power associated with the second SRS port is reduced to match the transmit power associated with the first SRS port.

17. The apparatus of claim 15, wherein the transmit power associated with the second SRS port is increased to match the transmit power associated with the first SRS port.

18. The apparatus of claim 15, wherein the indication comprises a medium access control (MAC) control element (MAC-CE).
